(19) United States
(12) Patent Application Publication
(10) Pub. No.: US 2009/0130269 A1
(43) Pub. Date: May 21, 2009

(54) FORMATION OF SUGAR COATINGS

(75) Inventors: Linda Jane McCausland, West Lafayette, IN (US); Neil Maxted, Oxfordshire (GB); Anthony James Brown, Berkshire (GB); Ian Humphrey Smith, Berkshire (GB)

Correspondence Address: LAW OFFICES OF WILLIAM H. HOLT, 12311 HARBOR DRIVE, WOODBRIDGE, VA, 22192, US

(73) Assignee: ACCENTUS PLC, London (GB)

(21) Appl. No.: 11/571,718

(22) PCT Filed: Jul. 6, 2005
(86) PCT No.: PCT/GB05/50104

§ 371 Date: Aug. 18, 2008

(30) Foreign Application Priority Data
Jul. 7, 2004 (GB) 0415237.7

(51) Int. Cl. A23P 1/08; A23L 1/025; A23G 3/26; B01D 9/00

(52) U.S. Cl. 426/238; 426/295; 118/19; 99/451

(57) ABSTRACT

A sugar coating is formed on a solution multiplicity of items (5) such as confectionery, using a suspension of crystal nuclei in a solution of sugar. This suspension is created by ultrasonic irradiation of a supersaturated solution. For example a saturated solution is cooled, and stored in a tank (16) connected to a recirculation (10) loop (18) containing a pump (24) and an ultrasonic irradiation module (26). Treated suspension (20) is withdrawn to coat items (11), and new supersaturated solution (14) is introduced. The sugar solution is sufficiently viscous to suppress crystal growth.

This invention relates to a process and apparatus for forming a sugar coating, for example on the surface of an item of confectionery such as a chocolate drop or chewing gum.

The provision of sugar coatings on sweets such as chocolates or on chewing gum is known. Such coatings may be deposited by making a concentrated sugar solution, and mixing the sweets with this solution so as to coat the sweets, for example while tumbling the mixture and evaporating the water (solvent). This is currently carried out using syrups that are initially undersaturated, and become supersaturated on the surface of the confectionery as a result of cooling and evaporation. Crystallisation of the sugar occurs at the surface of the sweets, so as to form a layer or coating of sugar. It is desirable that the sugar coating should have a crunchy texture, and this can be achieved by depositing a multiplicity of layers of sugar in succession.

The term sugar in this specification refers to any of the sugars and sugar replacers that are very soluble in water, producing a highly concentrated syrup which is in many cases significantly more viscous than water, and which are used for coating confectionery or other items. For example it would include sucrose, maltose, lactose, mannose and xylose; and sugar replacers such as maltitol, isomalt (alpha-D-glucopyranosido-1, 6-sorbitol and alpha-D-glucopyranosido-1, 6-mannitol), sorbitol, mannitol, xylitol, or erythritol. Such materials typically have a solubility above 30% (w/w) (ie 30 g/100 g of solution) at a temperature of 50° C., many having a solubility in excess of 50% (w/w), sucrose for example having a solubility of about 71% (w/w) at this temperature.

According to the present invention there is provided a process for forming a sugar coating on a multiplicity of items, the process comprising making a sugar solution that is supersaturated, subjecting the supersaturated sugar solution to ultrasonic irradiation of such an intensity and duration as to create a suspension of crystal nuclei, and then coating the items with the suspension containing the crystal nuclei.

It has hitherto been found difficult to bring about crystallisation of sugar in a controlled fashion, because sugar is so soluble; it forms a syrup which can remain stable for prolonged periods cooled below the saturation temperature for that concentration, despite being supersaturated. On the other hand, once crystallisation commences, for example when making fudge, it spreads rapidly throughout the syrup until the supersaturation has been relieved. It has been found that ultrasonic irradiation (ie insonation) of such syrup creates very small crystals, which may be referred to as crystal nuclei, and which are less than 5 μm in size; this process is one of primary homogeneous nucleation. Surprisingly, these crystal nuclei remain in suspension and grow slowly. The slow growth may be due to the high viscosity of the liquid phase.

For example with a 75% by weight solution or syrup of maltitol in water the solution would be saturated at about 60° C. As a general rule, the more the syrup is cooled below the saturation temperature the more likely nucleation is to occur, e.g. when subjected to ultrasound; however such a syrup has a high viscosity which increases as the temperature is lowered, and this increase in viscosity inhibits the rate of crystallisation by lowering the mobility of the sugar molecules, and this is more profound as the temperature approaches the glass transition. If insonation is performed at too low a temperature crystallisation does not appear to occur, while if insonation is performed at too high a temperature (but below the saturation temperature) then crystal growth will be rapid once crystal nuclei have formed as long as the solution remains supersaturated. For a particular solution it is possible to select a temperature range within which nucleation occurs but crystal growth is slow, crystal sizes showing no apparent change over a period of minutes, and which may be as long as 30 minutes to one hour. Hence there may be a significant time interval between the insonation, and the use of the solution for coating items; this would typically be greater than 10 seconds, and may be greater than 4 minutes.

In one example, a supersaturated sugar solution is subjected to ultrasonic irradiation for a brief period of no more than a few minutes, and is then used to coat the items. In another example the solution is subjected to prolonged or continuous irradiation, for example by recirculation through an irradiation duct, so to obtain a solution which is no longer supersaturated but which contains a multiplicity of crystals. In the latter case the crystals may be substantially monodisperse, with a size of about 5 μm or less, and are preferably no larger than 10 μm. In each case the nuclei are generated in situ in the sugar solution, before this is used in the coating step. Coating items with such a sugar solution that already contains crystal nuclei, which may be done using conventional coating equipment, produces a good quality sugar coating. The coating process is somewhat more rapid, and the required crunchy texture can be achieved using fewer coats.

Thus the irradiation may be carried out on a batch of solution prior to its use, or may be carried out on a continuous basis. The irradiation is preferably carried out continuously, or substantially continuously (for example as a sequence of pulses), and may be applied to all the solution at once, or to only part of the solution. For example, the ultrasonic irradiation may be carried out by recirculating syrup from a storage tank through a recirculation duct, and continuously subjecting the contents of the duct to ultrasonic irradiation. Alternatively a storage tank may be fitted with ultrasonic transducers on its walls, these being energised to irradiate the contents of the tank with ultrasound. In either case a solution that contains crystal nuclei in suspension would be tapped off from the storage tank for the coating process, and fresh syrup may be added to make up the volume in the storage tank.

In the case of the irradiation duct, ultrasound may be applied using a multiplicity of ultrasonic transducers attached to a wall of the duct in an array of separate transducers extending both circumferentially and longitudinally, each transducer being connected to a signal generator so that the transducer radiates no more than 8 W/cm², more typically about 1.5 W/cm², the transducers being sufficiently close together and the number of transducers being sufficiently high that the power dissipation within the vessel is between 50 and 500 W/litre, typically between 75 and 200 W/litre.

A problem with such sugar solutions is that they are typically very viscous compared to water, and consequently the cavitation events (caused by ultrasound) that bring about nucleation cannot always be satisfactorily and reliably attained at levels of power dissipation (such as 50 W/litre) which would be adequate for other liquids. Bubbles may form due to ultrasonic irradiation, but they do not undergo the rapid and complete collapse that seems to trigger a nucleation site; instead the liquid tends to undergo streaming. However, by operating at a higher power density, satisfactory cavitation and nucleation have been found to occur.

Preferably the duct is of width at least 0.10 m, that is to say if the duct is cylindrical it is of diameter at least 0.10 m. The values of power given here are those of the electrical power delivered to the transducers, as this is relatively easy to determine. Such an irradiation vessel is described in WO 00/35579. With such a vessel there is little or no cavitation at the surface of the wall, so that there is no erosion of the wall and consequently no formation of small particles of metal.

In a second aspect, the invention provides a process for making a suspension of sugar crystal nuclei in a saturated sugar solution, by subjecting a supersaturated sugar solution to ultrasonic irradiation.

The invention also provides an apparatus for performing these processes. Such an apparatus would comprise a vessel in which a supersaturated sugar solution is subjected to ultrasonic irradiation; and a separate vessel in which items are coated with the resulting solution.

The invention will now be further and more particularly described by way of example only and with reference to the accompanying drawings, in which:

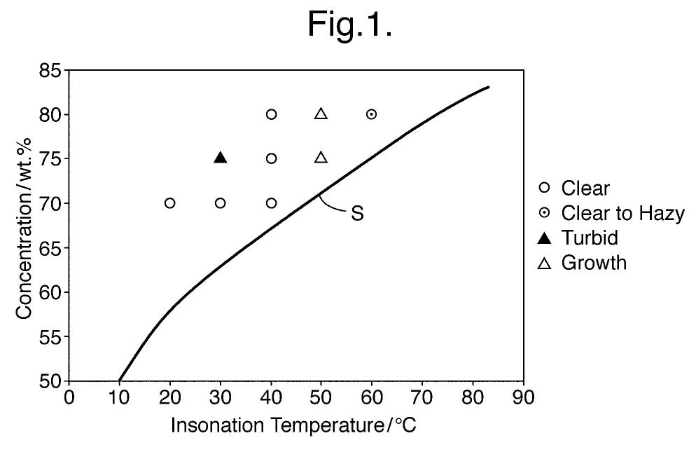

FIG. 1 shows graphically the effects of irradiation with ultrasound on supersaturated solutions of maltitol;

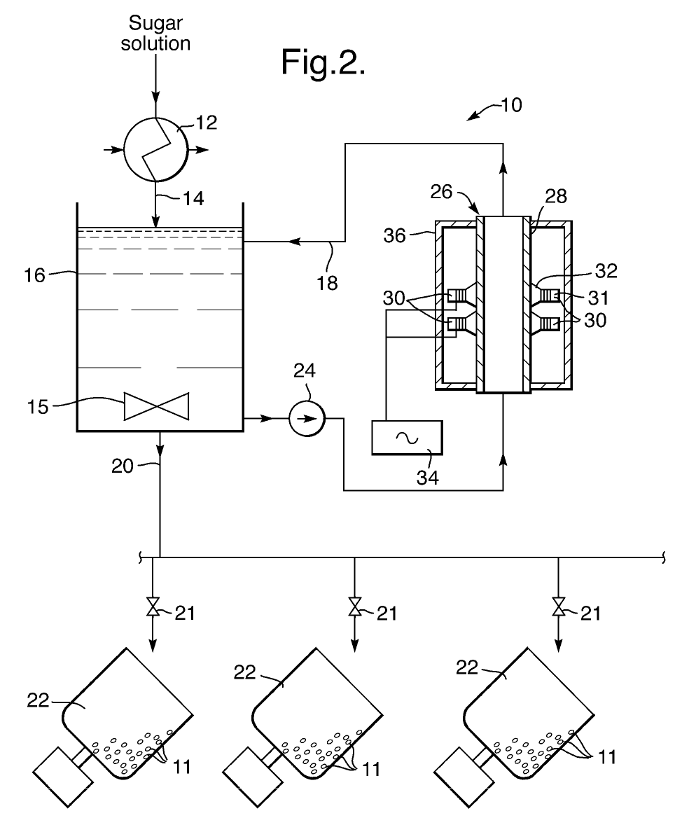

FIG. 2 shows a flow diagram of plant for coating items with sugar;

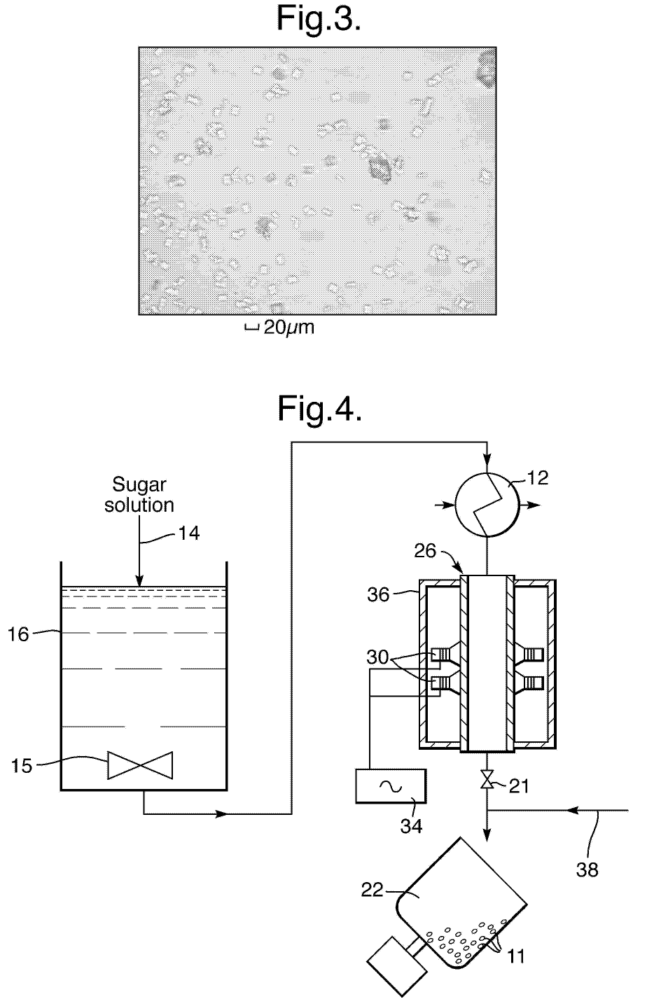

FIG. 3 shows a photograph of sugar crystals produced in the plant of FIG. 2; and

FIG. 4 shows a flow diagram of an alternative plant to that of FIG. 2.

Experimental observations have been made using maltitol syrups, that is to say aqueous solutions of maltitol of composition 70, 75 or 80% (by weight). Each such solution was made at 80° C., and then cooled to a temperature below its saturation temperature before being subjected to insonation for 4 minutes at a frequency of 20 kHz and an intensity 1.5 W/cm², and a power density of 105 W/litre. The solutions were inspected visually for turbidity and other evidence of the formation of crystals, this examination being carried out immediately after insonation, and then after remaining at the temperature of insonation for 30 minutes, and finally after cooling by a further 10° C.

Referring to FIG. 1, the results of this final inspection are shown on a graph, the graph axes indicating the solution concentration, and the temperature at which insonation had been performed. The curved line S shows the values of temperature at which the solution becomes saturated; it will be appreciated that all the observations are at temperatures below the saturation temperature.

It will be observed that insonation of these syrups at about 50° C. results in rapid crystal growth. This is observed for the 75% and 80% solutions, which are sufficiently supersaturated at this temperature to undergo nucleation, and have sufficiently low viscosity for growth to occur rapidly and enough supersaturation for growth to occur leading to a visible change in appearance. However the 80% solution, if insonated at 60° C., produces only slight haziness, presumably because there is insufficient supersaturation for significant nucleation or growth to occur.

Insonation at or below 40° C. gives little evidence of crystal formation, any initial haziness rapidly dissipating, with the exception that the 75% solution insonated at 30° C. and subsequently cooled does exhibit turbidity. In contrast the 75% solution insonated at 40° C. remains clear, presumably because there is insufficient supersaturation for crystal growth to occur (the viscosity being higher than at 50° C.). An aim of the present invention is to produce solutions that behave similarly to the 75% solution insonated at 30° C.; at this part of the concentration/temperature domain nucleation occurs, as evident by the turbidity, but crystal growth is slow because of the high viscosity and limited supersaturation.

Referring now to FIG. 2, a plant 10 is shown for providing a sugar coating on to tablets 11 of chewing gum. The sugar (e.g. sucrose) is dissolved in hot water so it is saturated at 75° C., and is then cooled, through one or more heat exchangers 12 (for example ending up at 40° C.), so that the resulting syrup 14 is supersaturated. In this state it is very viscous and the sugar tends not to come out of solution readily. The syrup 14 is fed into a storage tank 16 which is held at this temperature, and kept stirred by stirrer 15. A solution 20 containing crystals of sugar in suspension, formed as described below, is tapped off from the base of this tank 16 and supplied via valves 21 to several tumbler/driers 22 (only three are shown), such as sugar coating pans, containing the tablets 11 of chewing gum. Dry air at about 30° C. is blown through each tumbler/dryer 22.

It will be appreciated that this plant 10 is shown only as an example. In one alternative, a single tumbler 22 may be supplied by a single storage tank 16. In this case the valve 21 is preferably immediately adjacent to the tank 16. Furthermore, in this case, a source of compressed air (not shown) is preferably connected immediately downstream of the valve 21 so that any of the solution 20 which is downstream of the valve 21 can be blown out into the tumbler 22, when the valve 21 is closed, so that this solution 20 does not remain static in that part of the flow path.

Referring again to FIG. 2, the storage tank 16 is connected to an ultrasonic treatment loop 18 around which syrup 14 from the storage tank 16 is continuously circulated by a pump 24. Within the loop 18 is an ultrasonic treatment module 26. The dimensions of the plant 10 depend upon the quantities of syrup 14 to be processed, but for example the loop 18 may typically be of nominally six inch (150 mm) diameter pipe, and the ultrasonic treatment module 26 comprises a stainless-steel duct 28 of the same internal diameter.

To the outside of the wall of the duct 28 are attached ten transducer modules 30 in a regular array. Each transducer module 30 comprises a 50 W piezoelectric transducer 31 which resonates at 20 kHz, attached to a conically flared aluminium coupling block 32 by which it is connected to the wall, the wider end of each block 32 being of diameter 63 mm. The transducer modules 30 are arranged in two circumferential rings each of five modules 30, the centres of the coupling blocks being about 105 mm apart around the circumference, and about 114 mm apart in the longitudinal direction. A signal generator 34 drives all the transducers 31. The transducer modules 30 are enclosed by a protective casing 36.

With this irradiator module 26 the power intensity is about 1.6 W/cm², and is such that cavitation does not occur at the surface of the wall, so erosion of the duct 28 does not occur. Nevertheless the power density is sufficient to ensure nucleation in the supersaturated solution. The volume of liquid which is subjected to insonation is about 5 l, so the power density is about 100 W/litre. (The power density can be adjusted by adjusting the power supplied to the transducers 40, but is usually between 75 and 200 W/litre.) It will be appreciated that the power density may be also increased by arranging a larger number of transducers closer together. And it will also be appreciated that a larger module may instead be used, of larger diameter, so that a larger volume of solution can be irradiated at once; for example a longer and wider tube might have a volume of 30 litres, and be provided with sixty transducers in an array over its surface. The resonant frequency of the transducers may also differ, although typically frequencies between 16 kHz and 40 kHz are appropriate.

The coating procedure is first to introduce a batch of tablets 11 into a tumbler 22; add sufficient solution 20 to form a thin coating, mix thoroughly to coat all the tablets 11, dry; add sufficient solution 20 to form a second thin coating, mix thoroughly to coat all the tablets 11, dry; and repeat until the coating is sufficiently thick. The volumes of solution added at different stages may differ, so that the successive thin coatings may be of different thicknesses. Where there is more than one tumbler 22, it would usually be the case that the different tumblers 22 would be at different stages, and indeed different tumblers 22 might contain different confectionery items. Batches of the solution 20 are consequently tapped off at intervals, but the supersaturated syrup 14 may be introduced continuously into the storage tank 16. Nucleation occurs in the supersaturated liquid flowing through the ultrasonic treatment module 26, but the resulting crystals do not grow much larger than about 5 to 10 μm. The supersaturation in the storage tank 16 is removed, or at any rate it is decreased, as the solution is circulated around the loop 18; the small crystals remain suspended in a solution that may consequently be saturated rather than supersaturated.

Referring to FIG. 3, this shows a photomicrograph showing crystals of sugar suspended in saturated syrup, as produced by the apparatus 10, that is to say after residence in the tank 16 and recirculation around the loop 18. The crystals are at their maximum size, and are in the state in which they would be introduced into a tumbler 22. It will be appreciated from the photomicrograph that the crystals are substantially monodisperse, and are slightly less than 10 μm in size.

It will be appreciated that the plant shown in FIG. 2 may be modified in various ways, some of these modifications having been discussed briefly above. For example a module 26 may instead, or in addition, be provided in the duct carrying the syrup 14 from the heat exchanger 12 into the tank 16. However, if that is to be the only source of ultrasonic nucleation and removal of all residual supersaturation is desired, it is important that it provide enough power to ensure this will occur, even at the maximum flow rate of the syrup. This can be achieved by having a longer duct and a larger number of ultrasonic modules 30, for example ten or even twenty circumferential rings each of five modules 30.

In another alternative, transducers may be attached to the outside of the wall of a storage tank within which a sugar solution is circulated by a mixer. Such a tank may be coupled to a reservoir (not shown) containing supersaturated sugar solution, so that the level of the solution in the irradiated tank is maintained constant. The entire contents of the tank are irradiated substantially continuously, so that the tank contains saturated solution in which crystals are suspended. The solution and crystals can then be fed directly to the coating equipment. This arrangement may be preferable for sugar compounds whose crystal growth is more rapid.

In another alternative coating process, where the ultrasound is used only to create nuclei rather than to eliminate supersaturation, the supersaturated solution may be passed through an irradiation module 26 just once. Referring to FIG. 4, in which identical components are referred to by the same reference numerals, the module 26 is arranged in a flow path from a tank 16 containing a sugar solution to a valve 21 feeding a tumbler 22, with the valve 21 at the outflow from the module 26. A heat exchanger 12 is between the storage tank 16 and the irradiation module 26, such that the solution fed into the module 26 is supersaturated. The supersaturated solution is held in the module 26 for a period of time while being subjected to insonation, and then the desired quantity of treated solution is arranged to flow into the tumbler 22; the module is refilled; and any solution downstream of the valve 21 is blown out with compressed air from a line 38.

This process has been tested experimentally, and has been found to reduce the time needed to dry each layer of sugar deposited in the tumbler 22, so decreasing the overall production time. It has also been found to enable thicker layers of sugar to be deposited at one go, without the tablets (or “centres”) sticking together. These experiments were carried out using, as the sugar syrup, a solution of maltitol 66.4% (wt) with gum arabic (1.1%) and water, the gum arabic acting as a binding agent. This solution was prepared and stored in the tank 16 at 70° C., and cooled by passage through the heat exchanger 12 to about 40° C. as it was fed into the irradiation module 26. It was subjected to ultrasound for 4 minutes, to produce many small crystal nuclei. When required, insonated solution was then passed out through the valve 21 into the tumbler 22. The contents of the tumbler 22 were rolled for a preset period, and then dried; and the next batch of insonated solution was then added.

In one example the coating procedure applied twenty-nine successive coatings of sugar to a batch of 72 kg of chewing gum pellets, the quantity of syrup used to form each layer being gradually increased from 0.25 l up to 2.0 l, and then decreased to 0.5 l. Coated pellets consisting of 72.46% chewing gum and 27.54% sugar coating were produced in approximately 3 hours 40 minutes. Conventional coating techniques using higher temperature syrups and no ultrasound would take about 4 hours 20 minutes to build up this same sugar coating. Analysis of the sugar coatings show that they both contain the same moisture content and have the same microscopic structure. There is thus a considerable improvement in the time taken to deposit the coating. This appears to be a consequence of the greater proportion of free water in the insonated solution, which leads to a higher water vapour pressure and hence a higher rate of evaporation.

1. A process for forming a sugar coating on a multiplicity of items, the process comprising making a sugar solution that is supersaturated, subjecting the supersaturated sugar solution to ultrasonic irradiation of such an intensity and duration as to create a suspension of crystal nuclei, and then coating the items with the suspension containing the crystal nuclei.

2. A process as claimed in claim 1 wherein the suspension contains crystal nuclei in a saturated solution.

3. A process as claimed in claim 1 wherein the crystal nuclei are no more than 10 μm in size.

4. A process as claimed in claim 1 wherein the suspension is sufficiently viscous to suppress crystal growth.

5. A process as claimed in claim 1 wherein the irradiation is carried out on only part of the solution at any one time by recirculating syrup from a storage tank through a recirculation duct, and continuously subjecting the contents of the duct to ultrasonic irradiation.

6. A process as claimed in claim 1 wherein the ultrasonic irradiation is performed using a multiplicity of ultrasonic transducers attached to a wall of a vessel containing the solution, the transducers being sufficiently close together and the number of transducers being sufficiently high that the power dissipation within the vessel is between 75 and 200 W/litre.

7. An apparatus for performing a method as claimed in claim 1.

8. A method of forming a sugar coating on a multiplicity of items using a tumbler, in which the said items are placed in the tumbler, and batches of sugar solution are introduced, and the items rolled and subjected to a drying process before another batch of sugar solution is introduced, wherein the batches of sugar solution that are introduced contain crystal nuclei that have been generated by ultrasonic irradiation of a supersaturated solution.

9. An apparatus for forming a sugar coating on a multiplicity of items, the apparatus comprising a tumbler, means to supply batches of sugar solution to the tumbler, and means to insonate the sugar solution such that the batches supplied to the tumbler contain crystal nuclei generated by ultrasonic insonation.

10. An apparatus as claimed in claim 9 comprising a storage tank for sugar solution, and a recirculation duct connected thereto, the insonation means being provided in the recirculation duct.

11. An apparatus as claimed in claim 9 comprising a storage tank for a sugar solution, and a flow path to carry sugar solution from the storage tank to the tumbler, the flow path comprising a heat exchanger preceding an insonation means.
